(19) United States
(12) Patent Application Publication
(10) Pub. No.: US 2009/0064650 A1
(43) Pub. Date: Mar. 12, 2009

(54) CUTTING DECK, FRONT AXLE AND STEERING CONTROLS FOR A LAWN MOWER

(76) Inventors: J. Robert Eberle, Doylestown, PA (US); Jonathan F. Sente, Plymouth Meeting, PA (US); Carl T. Calianno, North Wales, PA (US); Rick Kramer, Wrightstown, PA (US)

Correspondence Address: FOX ROTHSCHILD LLP;PRINCETON PIKE CORPORATE CENTER, 2000 Market Street, Tenth Floor, Philadelphia, PA, 19103, US

(21) Appl. No.: 12/059,417

(22) Filed: Mar. 31, 2008

Related U.S. Application Data
(63) Continuation-in-part of application No. 60/908,926, filed on Mar. 29, 2007.

(51) Int. Cl. A01D 34/81

(52) U.S. Cl. 56/14.7; 56/320.2

(57) ABSTRACT

Improvements in frame designs, cutting deck designs, front axles designs for lawn mowers in general and improvements in steering controls of zero turn radius riding mowers are disclosed.

### CROSS-REFERENCE TO RELATED APPLICATIONS

This application is a continuation in part of U.S. Application Ser. No. 60/908,926, filed on Mar. 29, 2007, and incorporated herein by reference in its entirety.

### FIELD OF THE INVENTION

This invention relates generally to the field of lawn mowers. More specifically, it relates to improvements in frame designs, cutting deck designs, front axles designs for lawn mowers in general and improvements in steering controls of zero turn radius riding mowers.

### BACKGROUND OF THE INVENTION

Both commercial and residential lawn mowers are generally well known. For commercial purposes, riding mowers with multiple blade cutting decks are typically employed. Although different variations of cutting decks exist, there is still a need in the art for further improvements in the design of such decks. In addition, there is a need for improvement of suspension systems for riding lawnmowers.

In some riding lawn mowers, known as zero turn radius riding mowers, the speed of rear wheels is controlled individually by a steering lever. Operator can push or pull individual steering levers at different displacements to make mower turn at different turning radii. One problem that can occur is the operator needing to quickly shut off the power to the cutting deck or power to the engine in the event of an emergency. Conventional zero turn radius riding mowers have an emergency cut off switch mounted at the approximate level of the seat base. The operator must let go of one steering lever to activate the cut off switch. Since each steering lever must be controlled independently for steering, letting go of one lever may result in erratic, and potentially dangerous motion of the mower. Accordingly, improvements in steering controls for zero turn radius riding mowers are needed.

### SUMMARY OF THE INVENTION

The present invention fills the foregoing need by providing improved designs for cutting decks and suspension systems for riding lawnmowers in general, as well as improved controls particularly for zero turn radius lawn mowers.

The present invention generally comprises a frame with four wheels and tires. The engine is mounted in the rear and powers two hydraulic pumps, which in turn power individual real wheels for traction and turning. The engine also powers a cutting deck with multiple spindles and rotary cutting blades. An operator sits in a seat generally in the middle of the frame above the mid mounted deck. The operator controls the direction, speed and height of cut by controls within easy reach. The two steering levers are pivoted about an axis between the operator's feet. Each steering lever is pushed forward to make the corresponding rear wheel go forward at a rate proportional to the displacement of the steering lever from neutral position. Each steering lever is pulled rearward to make the corresponding rear wheel go backwards at a rate proportional to the displacement of the steering lever from neutral position. The deck is propelled by linkage attached to the frame. Grass and similar vegetation can be cut at a uniform height by engaging the multiple cutting blades and adjusting the deck to the desired height from the ground.

In one aspect, a cutting deck is provided. Such cutting deck may comprise a common channel having a discharge chute, and a plurality of helically-shaped blade chambers disposed along the common channel and fluidly connected to the common channel. The common channel preferably increases in volume toward the discharge chute. The volume of the common channel may be increased by increasing the common channel's width, depth or both. Even as the volume of the common channel changes, the volume of the blade chambers may stay the same.

The helically-shaped chambers comprise a helical ramp, a rounded baffle and a cut-off. The height of the helical ramp preferably decreases in the direction of the rotation of the blade. Due to height differences between the opposite ends of the helical ramp, a cutoff is formed between the center of the chamber and a high end of the chamber. The height of the cut-off may be increased with additional baffles.

In another aspect, a lawn mower is provided which comprises a frame and a cutting deck as described above attached to the underside of the frame.

In yet another aspect, a lawn mower comprises a frame, a cutting deck attached to the outside of the frame, an operator seat attached to the frame, rear and front wheels, a right steering lever and a left steering lever pivotally attached to the frame, wherein the steering levers are positioned in front of the operator's seat and substantially in the middle of the frame. A rollbar may also be included.

The engine start switch, throttle twist grip, deck height adjustment switch, or combinations thereof are preferably mounted on the steering levers. The steering levers are located between the legs of the operator sitting in the operator seat. The lawn mower may also include foot pegs attached to each side of the frame in multiple positions.

In another aspect, a lawn mower is provided comprising a frame, a cutting deck attached to the underside of the frame, an operator seat attached to the frame, rear and front wheels wherein the front wheels are attached to axle arms which are pivotally attached to the frame with separate torsion rods. Each torsion rod may comprise a pivoting bar coupled to a torsion spring.

### BRIEF DESCRIPTION OF THE DRAWINGS

The following drawings further illustrate embodiments of lawn mowers disclosed herein.

FIG. 1 is a perspective view of an embodiment lawn mower.

FIG. 1a is top view of one embodiment of the lawn mower's frame.

FIG. 1b is a bottom view of one embodiment of the lawn mower's frame.

FIG. 2 is a front view of an embodiment lawn mower.

FIG. 3 is a rear view of an embodiment lawn mower.

FIG. 4 is a side view of an embodiment lawn mower.

FIG. 5 is a top view of an embodiment lawn mower.

FIG. 6 is a bottom view of an embodiment lawn mower.

FIG. 7 is a perspective view of an embodiment lawn mower.

FIG. 8 is a view of an embodiment deck lift.

FIG. 9 is a view of an embodiment of deck support linkage.

FIG. 10 is a side view of an embodiment lawn mower.

FIG. 11 is a side view of an embodiment lawn mower.

FIG. 12 is a view of the underside of an embodiment of the cutting deck.

FIG. 13 is a view of the underside of an embodiment of the cutting deck.

FIG. 14 is a view of the underside of an embodiment of the cutting deck.

FIG. 15 is a view of the top of an embodiment of the cutting deck.

FIG. 16 is a view of the underside of embodiment of the cutting deck.

FIG. 17 is a view of the top of an embodiment of the cutting deck.

FIG. 18 is a view of an embodiment of the cutting disc and blades.

FIG. 19 is a close-up of an embodiment of the front portion of the frame.

FIG. 20 is a view of an embodiment of the spindle.

FIG. 21 is a view of an embodiment of the spindle.

FIG. 22 is a view of an embodiment of the spindle.

FIG. 23 is a view of an embodiment of the steering lever pivots and linkage.

FIG. 24 is a front view of an embodiment of the independently pivoting front axle.

FIG. 25 depicts one side of the independently pivoting front axle.

FIG. 26 is a bottom view of an embodiment of the independently pivoting front axle.

### DETAILED DESCRIPTION OF THE INVENTION

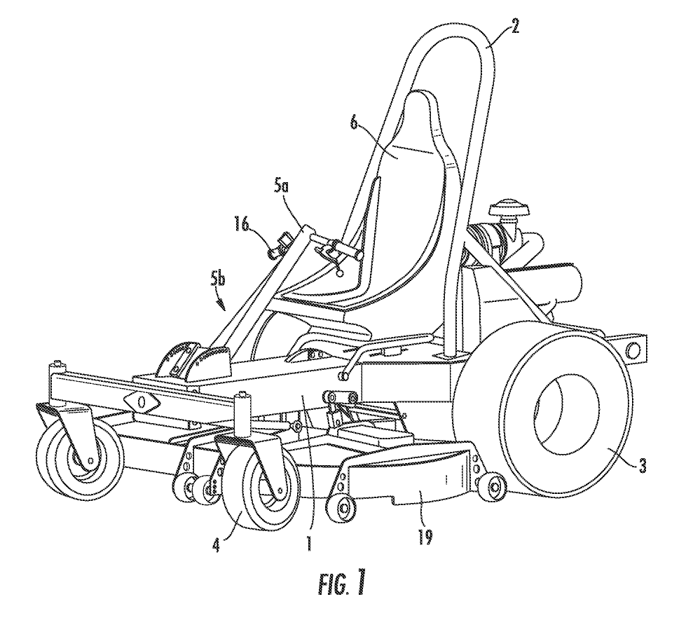

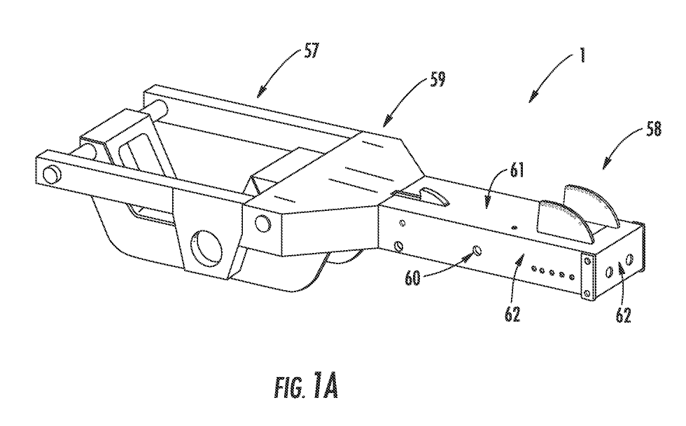

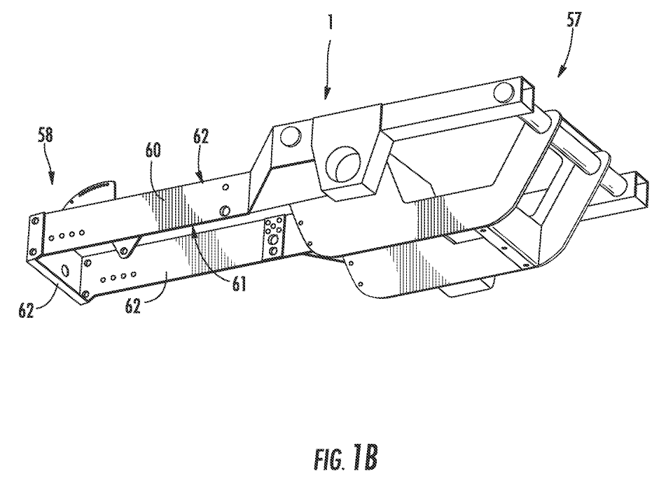

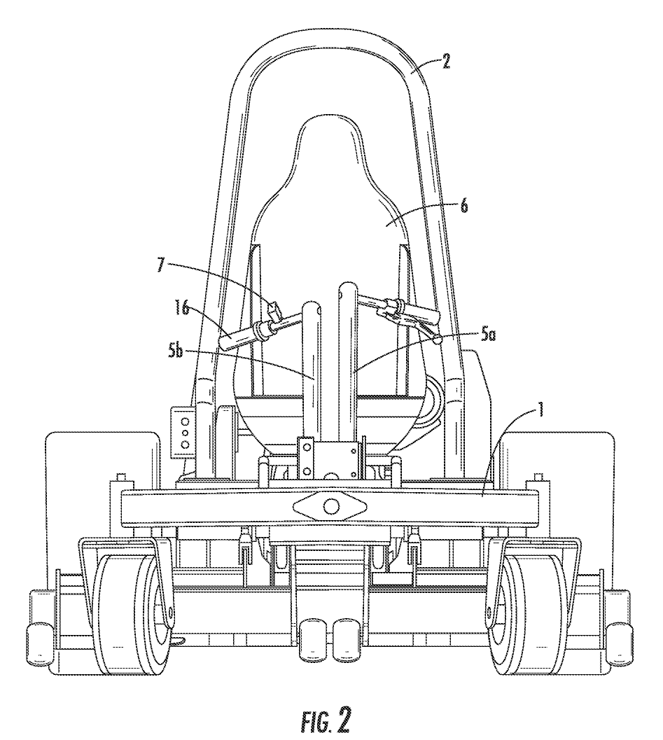

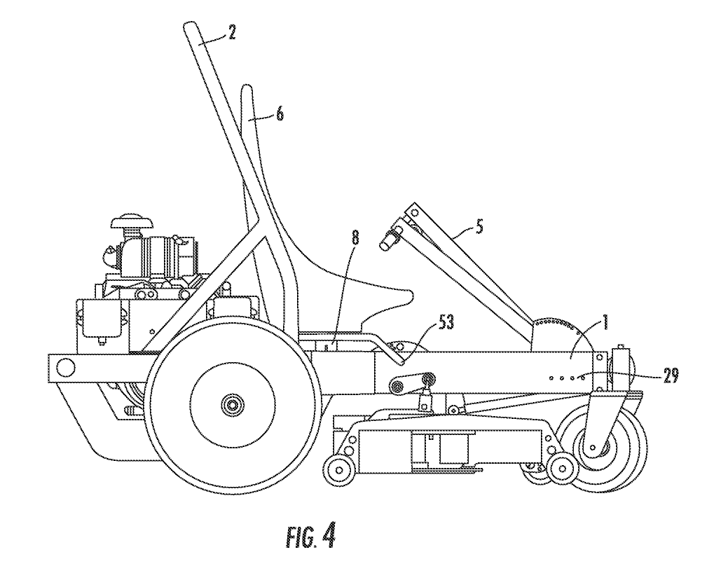

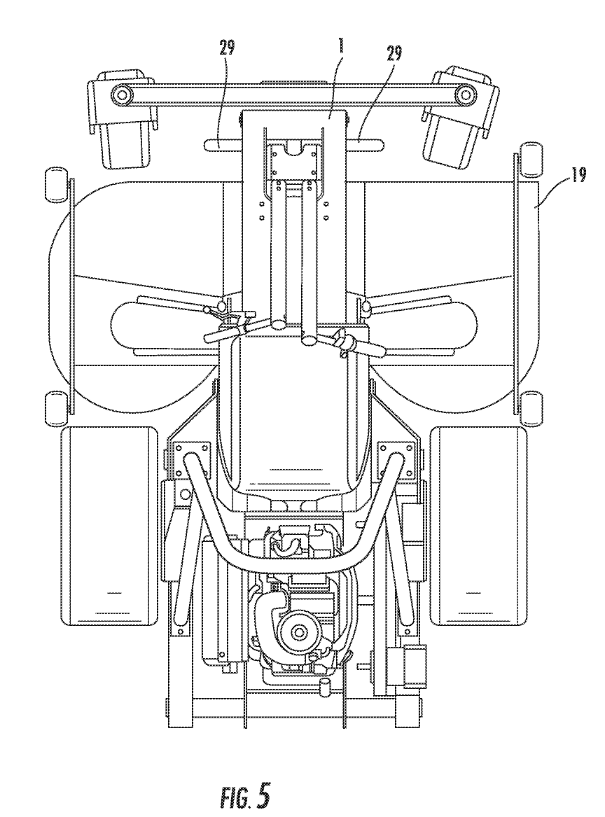

In one aspect, a lawn mower is provided. FIGS. 1 through 7 illustrate different views of lawn mowers disclosed herein. In general, the lawn mover comprises frame 1 with an integral rollbar 2, rear wheels 3 and front wheels 4. The engine is mounted in the rear and powers two hydraulic pumps, which in turn power individual real wheels for traction and turning. The engine also powers a deck with multiple spindles and rotary cutting blades.

The frame is preferably made from a sheet material such as metal, plastic, etc. Referring to FIGS. 1a and 1b, the frame 1 comprises a wider rear end 57 and a narrower front end 58. The operator seat may be positioned at position 59, near the transition between the front end and the rear end. In the front end, the sheet material may be cut and folded to form an enclosed elongated space 60 open on the bottom. In one embodiment, the elongated space may include a horizontal flat top 61 and vertical sides 62 extending down from the top. Alternatively, the walls and the top of the elongated space may be rounded. Deck linkage, deck actuation system, steering mechanism, wiring, etc. may be housed inside this elongated space for improved protection, safety and aesthetics. The elongated space may be left open, as shown in the figures, or may include a cover.

An operator seat 6 is attached to the frame 1 through a pivoting sub-frame. A left steering lever 5a and a right steering lever 5b are pivotally attached to the frame in front of the operator seat 6 and approximately in the middle of it. When an operator seats in the operator seats, the steering levers are located between the operator's legs. Steering levers pivoting between the operator's legs allow a more ergonomic steering lever movement than steering levers pivoted at the operator's side. The lawn mower also includes a cutting deck 19.

The operator seat 6 is positioned approximately in the middle of the frame 1. The seat is attached to the frame through a seat pivot 53 and an air spring 8. The air spring 8 provides shock and vibrations attenuation for increased operator comfort and safety. To overcome problems associated with known lawn movers, namely, to minimize motion transmitted to the operator from an uneven terrain and operator fatigue, the frame of the instant lawn mower, the seat pivot and the air spring are selected so the operator sits closer to the ground.

The steering levers 5a and 5b are pivotally attached to the frame 1. They are positioned between operator's legs for improved comfort and improved entrance and exit of the operator. The operator sits in the seat 6 and grasps one steering lever 5a or 5b in each hand. The operator pushes steering levers 5a, 5b forward to make mower go forward or pulls steering levers 5a, 5b rearward to make mower go in reverse. Operator pulls one steering lever backward and one steering lever rearward to make mower turn. Operator can push or pull individual steering levers at different displacements to make mower turn at different turning radii.

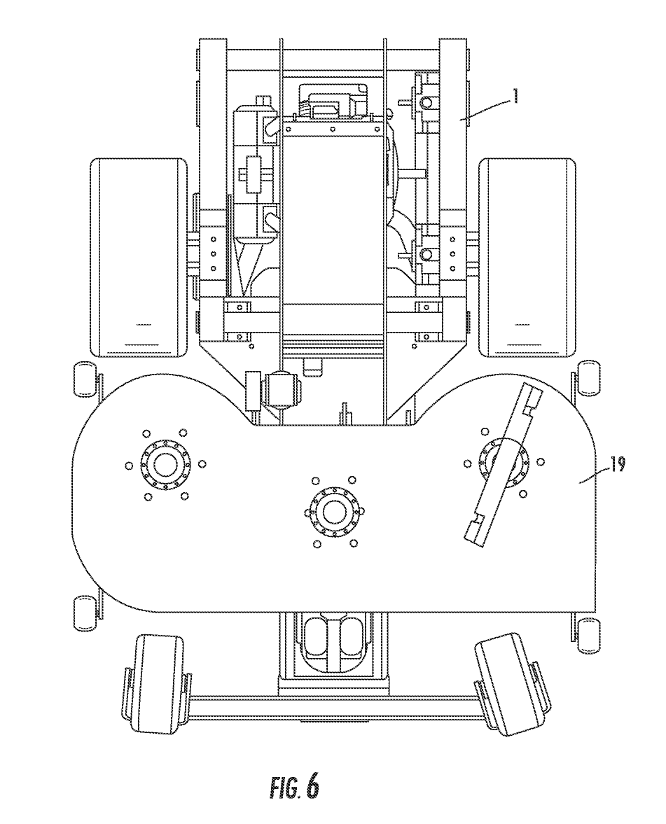

In FIG. 7, the steering levers 5a, 5b are shown in the most forward tilted position. They are adjustable for comfort and to accommodate operators of different sizes. Steering levers may lock in each position positively for safety. Because the steering levers may be tilted and latched into a vertical park position, operators are enabled to pull themselves up and out of the seat by gripping the steering levers and to easily get on or off the lawn mower.

Steering lever tilt locking arm 10 is pivotally attached to frame 1. In one embodiment, steering lever tilt release lever 9 is attached to steering lever 5a or 5b. Operator depresses steering lever tilt release lever 9 to disengage steering lever tilt locking arm 10, which allows steering levers to be repositioned without engaging traction motor pumps. In another embodiment, the tilt locking arm 10 may be disengaged by pushing the steering levers to the side.

While operating the lawn mower, the operator may need to quickly shut off the power to the cutting deck, or power to the engine, or both in the event of an emergency. Conventional zero turn radius riding mowers have an emergency cut off switch mounted at the approximate level of the seat base. The operator must let go of one steering lever to activate the cut off switch. Since each steering lever must be controlled independently for steering, letting go of one lever may result in erratic, dangerous motion of the mower. Accordingly, in the instant lawn mower, an engine on/off switch 7 and a throttle twist grip 16 may be attached directly to the steering levers 5a or 5b for safety in the event of an emergency.

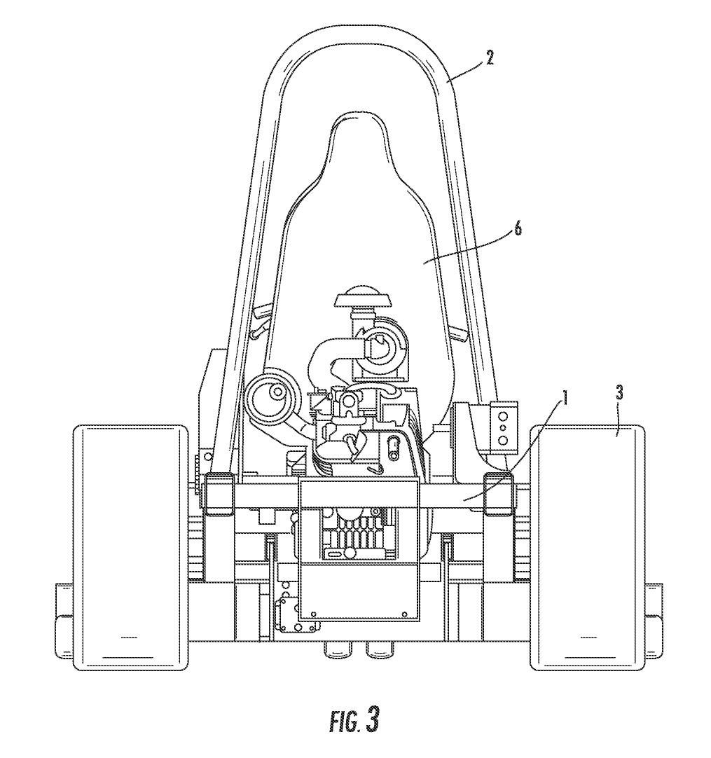

Referring specifically to FIG. 4, foot pegs 29 may be attached to the frame 1 in one of multiple positions. The pegs in combination with the steering levers' position in the middle of the frame further increases operator comfort and safety.

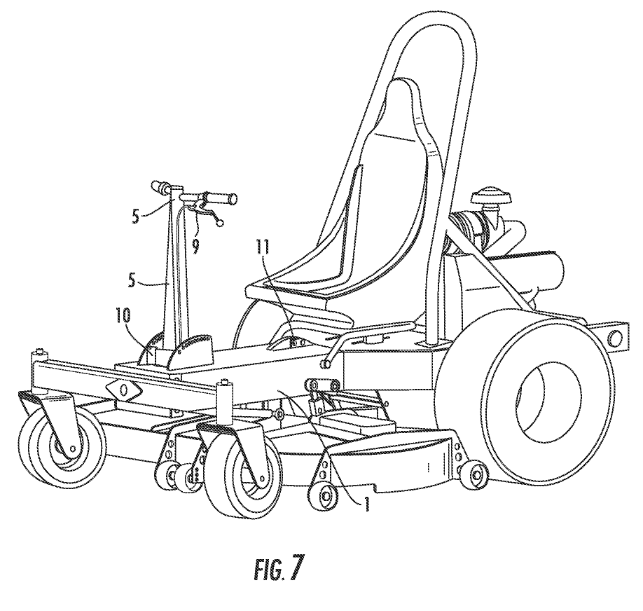

The cutting deck 19 is mounted to the center of the underside of the frame. The height of the cutting deck may be adjusted using the height adjustment mechanism depicted in FIGS. 8-11. FIG. 8 shows the height adjustment mechanism comprising a deck height adjustment wheel 11 stopped against a deck height adjustment stop 12 with a deck height adjustment stop pin 13. Linear actuator 48 raises the cutting deck using electrical power, then the cutting deck height adjustment stop pin 13 is installed into deck height adjustment wheel 11 for positive mechanical stop.

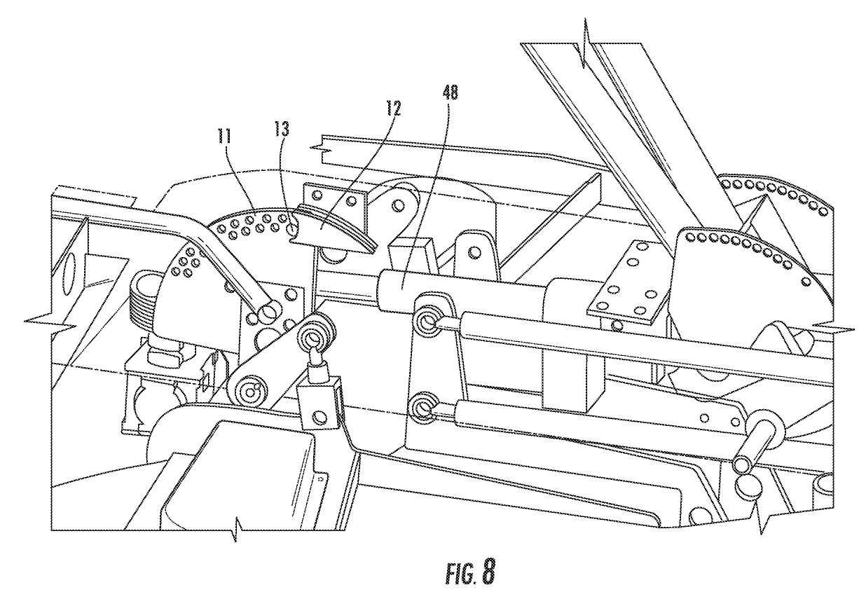

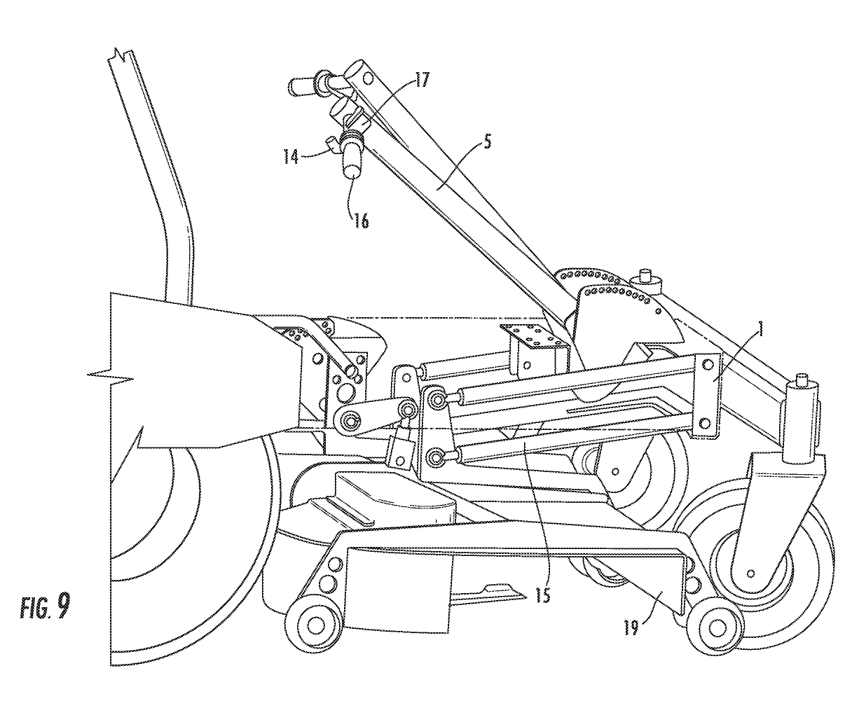

FIG. 9 shows the cutting deck bar linkage 15 pivotally mounted to frame 1 and deck 19. The bar linkage 15 keeps the cutting deck parallel to the frame and locates the cutting deck side to side. Similarly to the engine on/off switch 7 and throttle twist grip 16, the deck height adjustment switch is preferably mounted to the steering levers 5a or 5b for safety and convenience.

Referring to FIG. 10, the cutting deck lift linkage arm 18 is pivotally mounted to the cutting deck 19 and frame 1. The cutting deck 19 is in the highest height position for tall grass cutting and transport. The cutting deck may either be retained in this or any other position by the self locking feature of the lead screw of the actuator or may be mechanically locked by inserting deck height adjustment stop pin 13 is installed into deck height adjustment wheel 11.

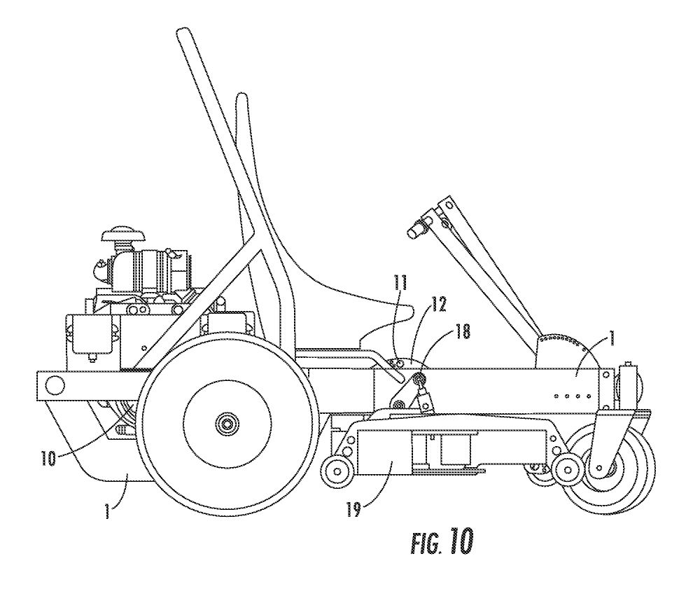

In FIG. 11, the cutting deck 19 is shown in the lowest height position, powered down by the linear actuator. As shown in FIG. 11, the deck height adjustment stop pin does not need to be installed since this lowest position may be beyond the range of the holes in deck height adjustment wheel. This position raises the front wheels of the mower to allow a jack stand or similar device to be placed under the front axle for servicing of the deck, or cutting blades.

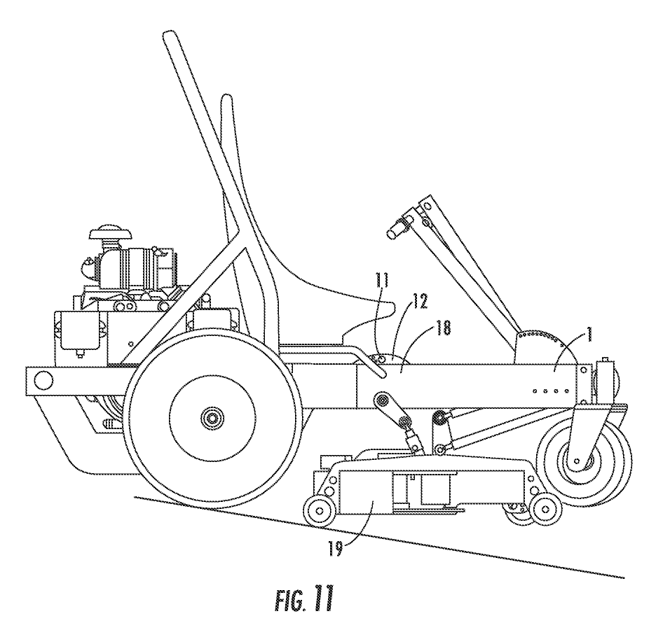

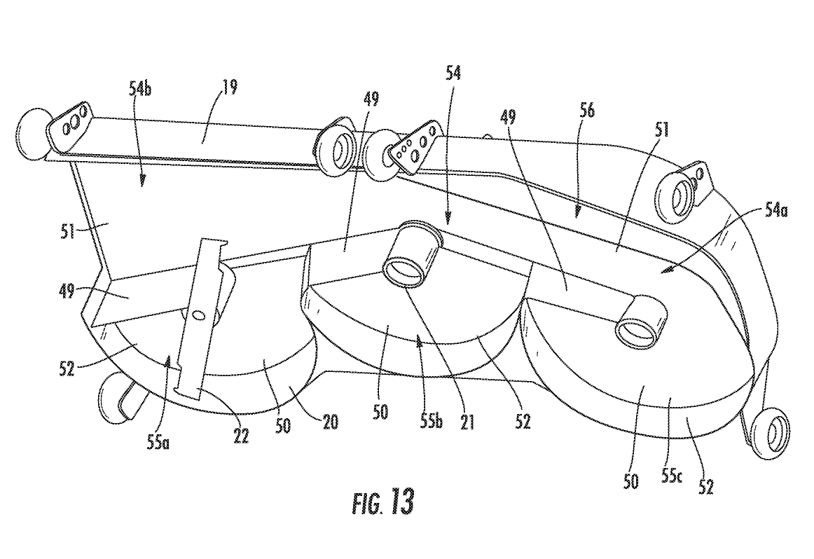

FIGS. 12 to 14 show one embodiment of the cutting deck. As shown in FIG. 14, the cutting deck may comprises a deck 19, a deck spindle 21, and a deck liner 20. In some embodiments, the deck liner 20 may be removably attached to the deck as shown in FIG. 14. In such embodiments, the liner may be removed for cleaning or for replacement of liner. Liner may be made of molded plastic or other material that allows smooth radii and a surface that does not easily allow grass and other debris to accumulate. In other embodiments, the liner may be permanently attached to the cutting deck, or alternatively the liner may be excluded all together.

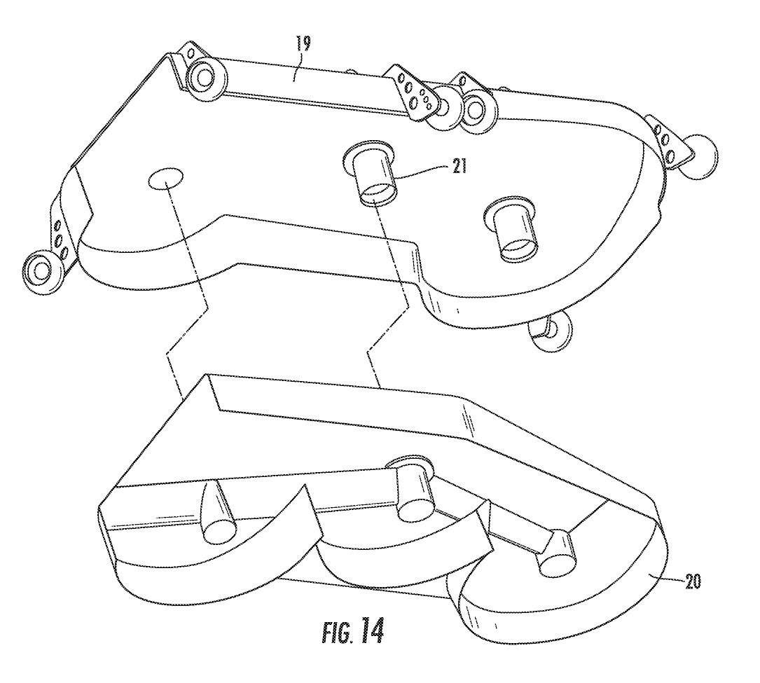

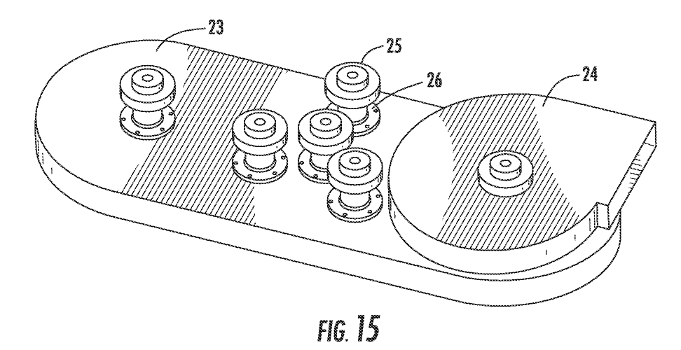

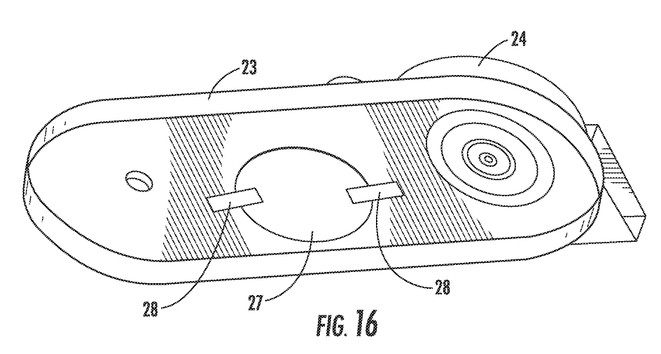

Different designs of cutting decks may be used in lawn mowers disclosed herein. In preferred embodiments, the cutting decks described in detail below may be utilized. Alternatively, the instant lawn mower may include a cutting deck as shown in FIGS. 15 through 17. Such design may comprise a blower deck 23 attached to a blower deck spindle 26, a pulley 25 and a blower 24. The blower increases the airflow by centrifugal pumping. In FIG. 17, the blower is not depicted to show air flow path through the top of the cutting deck.

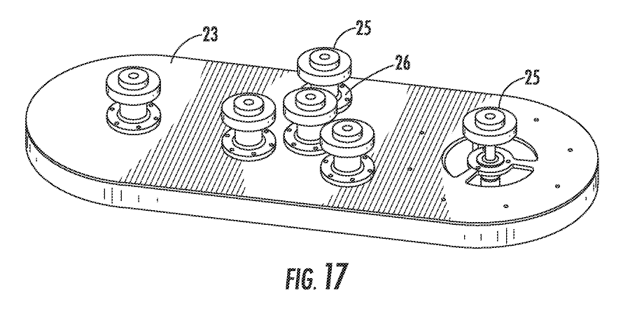

FIG. 18 shows a blade disc that may be suitable for use with the instant lawn mower. It comprises a swing away blade 28 attached pivotally to blade disc 27. This design enables the blade to fold back if the blade impacts an object that may cause damage to the blade or the cutting deck.

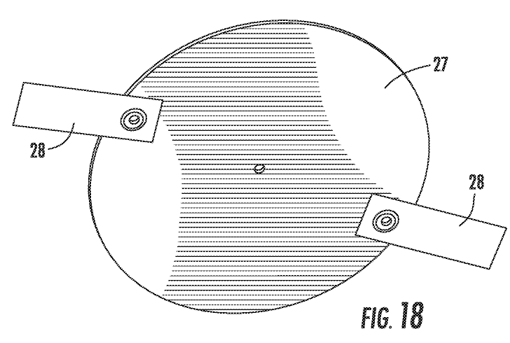

Referring to FIG. 19, a rotary cam 32 is attached to the shaft of a pivoting front axle 33 such that it moves the linear actuator 48 rearward when either wheel attached to the pivoting front axle encounters a rise in the terrain. This rearward movement of the linear actuator raises the cutting deck 19 through linkage and deck lift linkage arm 18. Steering lever tilt locking pin 30 engages steering lever tilt locking slots 31 in any of the positions to allow adjustment of the steering lever position to accommodate operators of various sizes for comfort and safety.

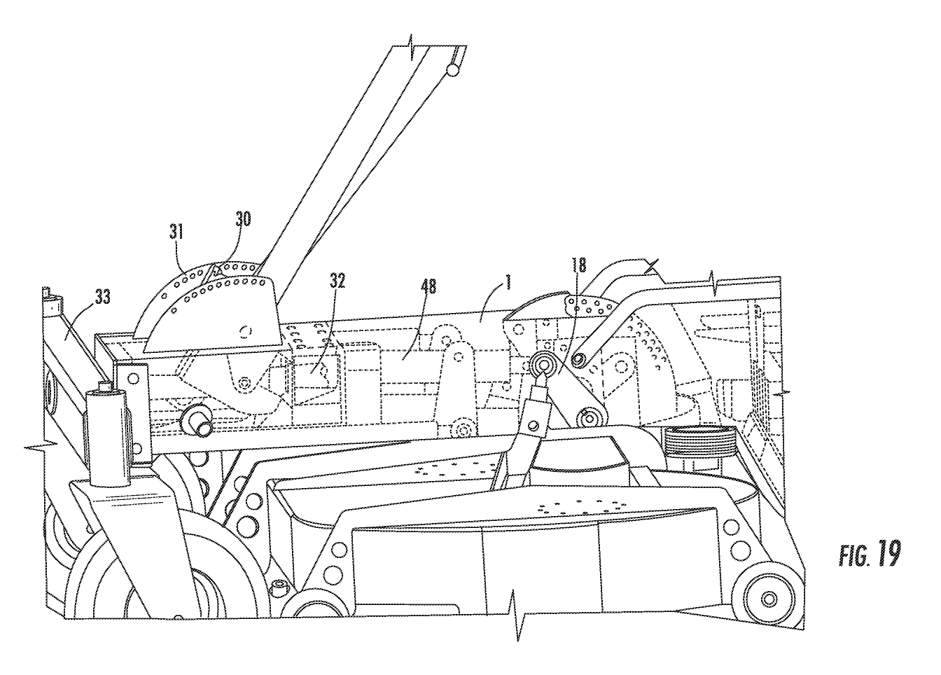

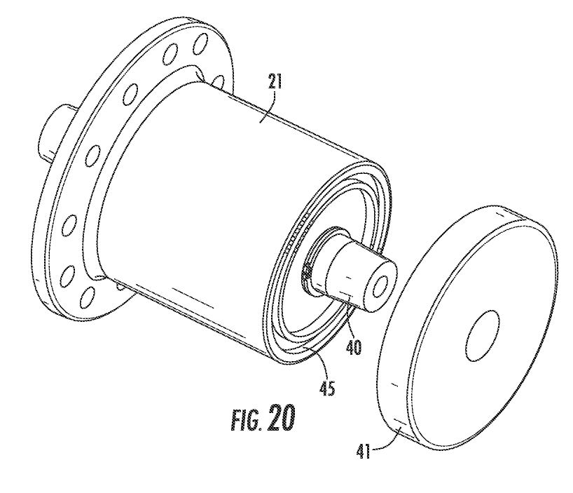

FIGS. 20 and 21 show a deck spindle 21 with a spindle shaft 40 and a blade hub 41. The spindle may be preferably teardrop-shaped to improve air flow about the spindle and to reduce grass buildup. A labyrinth seal may preferably be used to attach the hub because the labyrinth seal may be more effective than other types of seals in rejecting debris than cup or disc shaped debris shields. The labyrinth seal may be machined, cast, or molded into the deck spindle and the blade hub.

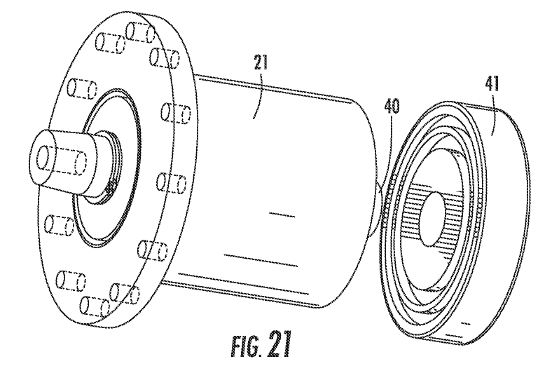

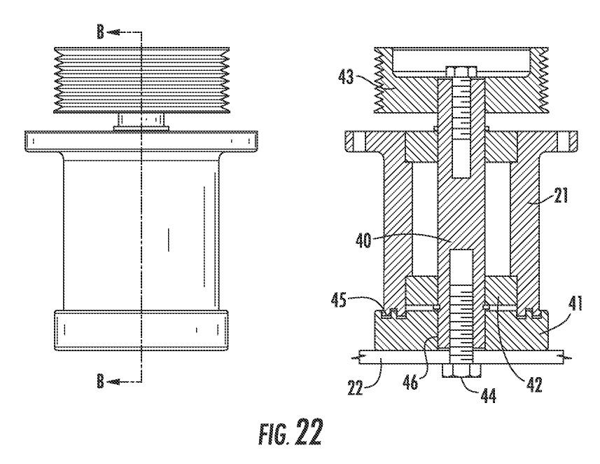

FIG. 22 shows the deck spindle 21 with the spindle shaft 40, the blade hub 41, spindle bearings 42, spindle pulley 43, and a spindle bolt 44. Deck spindle 21 and blade hub 41 mount so that a labyrinth seal is formed to keep debris from the bearing 42. Spindle shaft 40 and blade hub 41 may include matching tapers that lock them together when spindle bolt 44 is tightened. No key and keyway or splines are necessary to transmit torque. The high friction between the tapers transmits high torque, and will allow limited rotation relative to each other in the event of a significant impact of the blade against a large object, reducing damage to the blade and the deck components. The spindle pulley 43 is attached to the spindle shaft with a taper and spindle bolt.

In FIG. 23, a steering lever tilt pivot base 35 is shown attached to the frame 1. Steering levers 5a, 5b are pivotally attached to a steering lever tilt pivot bracket 34, which is pivotally attached to the steering lever tilt pivot base 35. Steering control rod 39 is pivotally attached to the steering lever tilt pivot bracket 34 at steering lever tilt pivot 36. Preferably, they are attached using geometry designed to allow entire tilt mechanism to pivot about steering lever tilt pivot with no relative change in the position of steering control rods 39, therefore no change in neutral position of steering control rods.

Park position locking bar 38 is attached to the steering lever tilt pivot bracket 34 and engages annular rings that are part of or attached to steering control rods 39, preventing movement from neutral when steering lever tilt mechanism is in full vertical or park position.

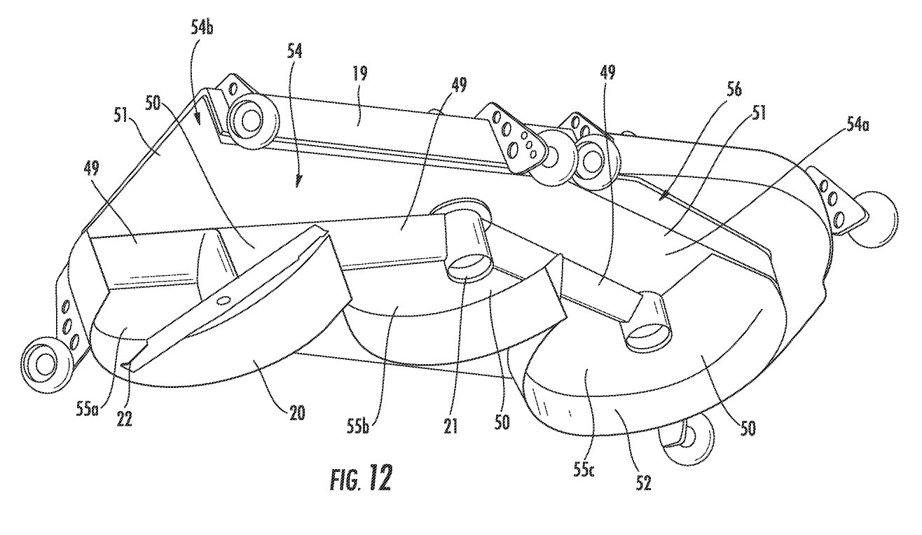

In another aspect, a novel cutting deck is provided. It will be understood that such cutting decks may be used with lawn mowers disclosed herein, as well as any other type of lawn mowers with multiple blade cutting decks. As shown in FIGS. 12 and 13, a novel cutting deck comprises a common channel 54 having a discharge chute 51, and multiple helically-shaped blade chambers 55 fluidly connected to and located along the common channel. In a preferred embodiments, there are three blade chambers 55a, 55b, and 55c. Blade spindles 21 may be positioned in the center of each blade chamber.

The common channel 54 is disposed on one side of the cutting deck. It is defined by a retaining wall 56 on one side and blade chambers on the other side. The air carrying the grass clippings is moved by the blades from the chambers into the common channel and is ultimately forced out through the discharge chute 51. Preferably, once the air from the chambers enters the common channel, it stays in the common channel, i.e. does not re-enter the chamber where it originated or any other chambers, until it is ultimately pushed out through the discharge chute. Although the common channel is depicted in the figures with one discharge chute on the side, the position and number of chutes may be varied. For example, the grass may be discharged to the rear or both to the side and the rear. It will also be understood that the design of blade chambers may change according to position of the discharge chute. Thus, it may be desirable to orient the helical ramps in one direction if the discharge chute is on the side of the common channel, as shown in FIG. 12-14. On the other hand, if the discharge chute is in the middle of the common channel, the helical ramps may be oriented in opposite directions depending on whether the chamber is to the left or to the right of the discharge chute.

In the preferred embodiments, the volume of the common channel increases from the closed end or ends toward the discharge chute, i.e., from point 54a to point 54b when the discharge chute is on the side of the common channel. It can be achieved either by increasing the width of the common channel, by increasing the depth of the channel, or by both in combination. In the preferred embodiment, the volume of the common channel may be increased by progressively increasing its width toward the discharge chute 51.

The multiple blade chambers 55 are adapted to accept cutting blades 22. Each blade chamber 55 comprises a helical ramp 50 that increases air velocity and flow from the centrifugal and axial impeller forces of blade 22 when blade is rotating. The bottom part of the ramp is at substantially the same height as the common channel at that point. The angle of the helical ramp may be the same or different in different chambers. Preferably, the height of the ramp decreases in the direction of the rotation of the blade. Also preferably, the higher part of the ramp in a given chamber is closer to the discharge chute, as shown in FIGS. 12 to 14.

The higher part of the helical ramp creates an air cutoff 49 that blocks the air from shunting back through the helical ramp and forces the air out of the discharge chute 51. These cutoffs increase airflow and efficiency over the conventional cutting decks. In some embodiments, in addition to cutoffs inherently created by helical ramps, additional baffles may be attached to the cutoffs to increase the height of the cutoff.

The blade chambers may be defined by baffles 52, referred to herein as the chamber baffle. The baffles 52 may preferably be rounded, that is, have a compound corner radii. The compound corner radii may further increase airflow and efficiency by reducing turbulence commonly found in decks with sharp corners.

The cutting decks may comprise a liner having the improved design, as shown in FIG. 14. In other embodiments, the improved design may be embedded into the cutting deck itself.

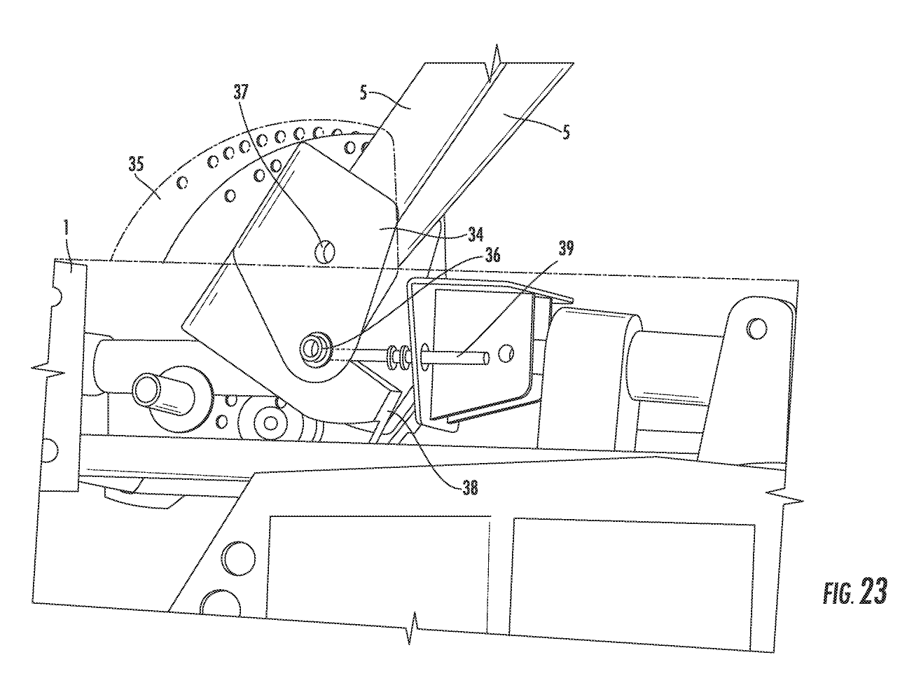

The front wheels may be attached to the frame using any type of axle or suspension known and used in the art. For example, in FIG. 1, a straight axle is shown. In the preferred embodiments, a front axle that enables front wheels to pivot independently of each other is utilized for the instant lawn mower. As depicted in FIG. 24, such front axle may comprise a left axle arm 63 and a right axle arm 64 attached to the frame 1 with separate torsion rods (not shown). Torsion rods allow the front wheels to move independently of each other in response to the terrain, as well as provide independent suspension to each wheel. In the preferred embodiments, each axle arm is attached to the frame by a single torsion rod.

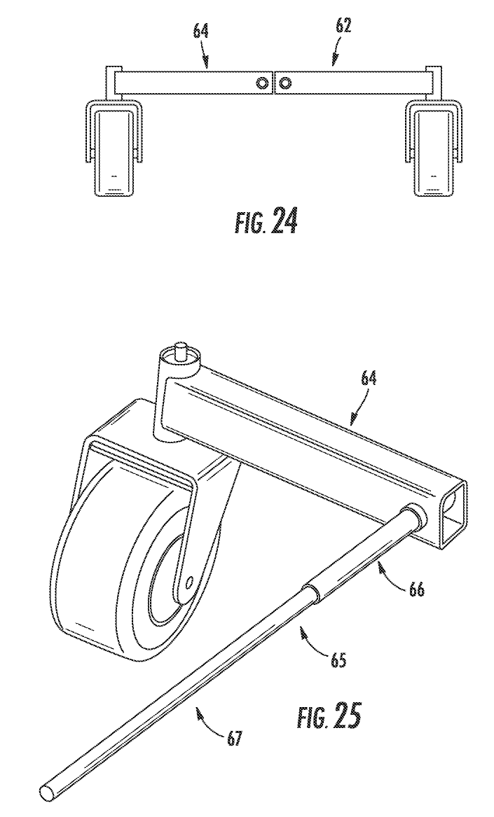

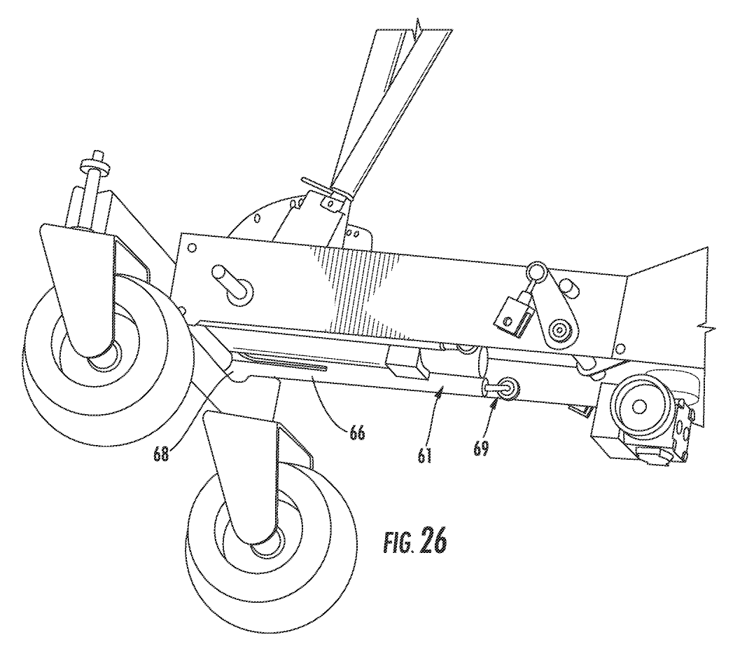

Referring to FIG. 25, the torsion rod 65 may preferably comprise a pivoting bar 66 coupled to a torsion spring 67. Referring to FIG. 26, at one end of the torsion rod 68, the pivoting bar 66 may attached to the corresponding axle arm and may enable the axle to pivot about the frame. At the other end of the torsion rod 69, the torsion spring 68 is adjustably attached to the frame. The load in the torsion spring may be adjusted which would adjust the amount the frame moves in response to uneven terrain encountered by the front wheels.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A cutting deck comprising:
a common channel having a discharge chute; and
a plurality of helically-shaped blade chambers disposed along the common channel and fluidly connected to the common channel.

2. The cutting deck of claim 1 wherein the common channel increases in width toward the discharge chute.

3. The cutting deck of claim 1 wherein the common channel increases in height toward the discharge chute.

4. The cutting deck of claim 1 wherein the helically-shaped chambers comprise a helical ramp, a cut-off and a rounded baffle.

5. The cutting deck of claim 4 wherein the height of the helical ramp decreases in the direction of the rotation of the blade.

6. The cutting deck of claim 4 wherein the bottom of the helical ramp is leveled with the common channel.

7. A lawn mower comprising:
a frame; and
a cutting deck attached to an underside of the frame comprising:
a common channel having a discharge; and
a plurality of helically-shaped blade chambers disposed along the common channel and fluidly connected to the common channel.

8. The mower of claim 7 wherein the common channel increases in width toward the discharge chute.

9. The mower of claim 7 wherein the common channel increases in height toward the discharge chute.

10. The mower of claim 7 wherein the blade chambers have the same volume.

11. The mower of claim 7 wherein the helically-shaped chambers comprise a helical ramp, a cut-off and a chamber baffle.

12. A lawn mower comprising:
a frame;
a cutting deck attached to the underside of the frame;
an operator seat attached to the frame;
rear and front wheels;
a right steering lever and a left steering lever pivotally attached to the frame, wherein the steering levers are positioned in front of the operator's seat and substantially in the middle of the frame.

13. The lawn mower of claim 12 wherein the cutting deck comprises a common channel having a discharge chute on one end, and a plurality of helically-shaped blade chambers disposed along the common channel and fluidly connected to the common channel.

14. The lawn mower of claim 12 further comprising an engine start switch, throttle twist grip, deck height adjustment switch, or combinations thereof mounted on the steering levers.

15. The lawn mower of claim 12 further comprising a rollbar.

16. The lawn mower of claim 12 further comprising foot pegs attached to the left side and to the right side of the frame.

17. The lawn mower of claim 16 wherein the foot pegs be attached in a multiple of positions.

18. The lawn mower of claim 12 wherein the frame comprises an enclosed elongated space at the front of the frame.

19. A lawn mower comprising:
a frame;
a cutting deck attached to the underside of the frame;
an operator seat attached to the frame;
rear and front wheels
wherein the front wheels are attached to corresponding axle arms which are pivotally attached to the frame with separate torsion rods.

20. The lawn mower of claim 19 wherein each torsion rod comprises a pivoting bar coupled to a torsion spring.
